(19) United States
(12) Patent Application Publication
(10) Pub. No.: US 2021/0122214 A1
(43) Pub. Date: Apr. 29, 2021

(54) SMART HEATING AND RECIRCULATING AIR MANAGEMENT (RAM) HEATING, VENTILATION, AND AIR CONDITIONING (HVAC) ASSEMBLY AND METHOD

(71) Applicant: Valeo North America, Inc., Auburn Hills, MI (US)

(72) Inventors: Earl Buckman, Auburn Hills, MI (US); Darshan Parikh, Auburn Hills, MI (US); Sally Dagher, Auburn Hills, MI (US); Steve Hrouska, Auburn Hills, MI (US); Nestor Isamael Varela Santoyo, Auburn Hills, MI (US); Philippe Pierres, Auburn Hills, MI (US)

(73) Assignee: Valeo North America, Inc., Auburn Hills, MI (US)

(21) Appl. No.: 16/663,693

(22) Filed: Oct. 25, 2019

(51) Int. Cl. B60H 1/00

(52) U.S. Cl. CPC B60H 1/00842; B60H 1/0073; B60H 1/00785

(57) ABSTRACT

A method for smart heating and Recirculation Air Management (RAM) using an HVAC assembly for a vehicle is disclosed. The method involves obtaining a first air pressure at a first fresh air inlet configured for allowing passage of fresh air in proportion to a first degree of aperture of the first fresh air inlet and the first air pressure, obtaining a second air pressure at a first recycled air inlet configured for allowing passage of recycled air in proportion to a second degree of aperture of the first recycled air inlet and the second air pressure, identifying a required mixed air pressure based on a combination of the first air pressure and the second air pressure, and dynamically modifying the first and second degrees of aperture to obtain the required mixed air pressure which remains constant regardless of parameters associated with the inside passenger cabin of the vehicle.

### BACKGROUND

In the automotive field, heating, ventilation, and/or air conditioning (HVAC) systems regulate the aerothermal parameters of the air circulated inside a passenger cabin. Air inlets are devices performing the functionality of allowing air flows from one area to another. A blower motor is a device performing the functionality of a centrifugal fan coupled with a motor used in moving air or other gases in/out of a cabin of a motor vehicle. Blower motors are assembled adjacent to air inlets that direct incoming/outgoing airflows in a specific direction or across a heat sink. Blower motors increase the speed and volume of an airflow using rotating impellers to move the airflows against the resistance caused by one or more ducted housings.

### SUMMARY

In general, in one aspect, embodiments disclosed herein relate to a method for smart heating and a Recirculation Air Management (RAM) using a heating, ventilation, and air-conditioning (HVAC) assembly for a motor vehicle, the method comprising obtaining a first air pressure at a first fresh air inlet, the first fresh air inlet being configured for allowing passage of fresh air in proportion to a first degree of aperture of the first fresh air inlet and the first air pressure, obtaining a second air pressure at a first recycled air inlet, the first recycled air inlet being configured for allowing passage of recycled air in proportion to a second degree of aperture of the first recycled air inlet and the second air pressure, identifying a required mixed air pressure, the required mixed air pressure being based on a combination of the first air pressure and the second air pressure, and dynamically modifying the first degree of aperture and the second degree of aperture to obtain the required mixed air pressure, wherein the required mixed air pressure is maintained constant irrespective of one or more parameters associated with an inside of a passenger cabin of the motor vehicle.

In general, in one aspect, embodiments disclosed herein relate to a heating, ventilation, and air-conditioning (HVAC) assembly for smart heating and a Recirculation Air Management (RAM) of a motor vehicle, the assembly comprising a first fresh air inlet configured for allowing passage of fresh air in proportion to a first degree of aperture and a first air pressure, and a first recycled air inlet configured for allowing passage of recycled air in proportion to a second degree of aperture and a second air pressure, and means configured to dynamically modify the first degree of aperture and the second degree of aperture to maintain a mixed air pressure constant irrespective of one or more parameters associated with an inside of a passenger cabin of the motor vehicle, and wherein the first air pressure and the second air pressure are combined to form a required mixed air pressure.

In general, in one aspect, embodiments disclosed herein relate to a Recirculation Air Management (RAM) air intake for a heating, ventilation, and air-conditioning (HVAC) assembly for smart heating and RAM of a motor vehicle, the assembly comprising a first fresh air inlet configured for allowing passage of fresh air in proportion to a first degree of aperture and a first air pressure, a first recycled air inlet configured for allowing passage of recycled air in proportion to a second degree of aperture and a second air pressure, and means configured to dynamically modify the first degree of aperture and the second degree of aperture to maintain a mixed air pressure constant irrespective of one or more parameters associated with an inside of a passenger cabin of the motor vehicle, and wherein the first air pressure and the second air pressure are combined to form a required mixed air pressure.

Other aspects of the disclosure will be apparent from the following description and the appended claims.

### BRIEF DESCRIPTION OF DRAWINGS

FIG. 1 shows a block diagram of an automotive system in accordance with one or more embodiments.

FIG. 2 shows a block diagram of an automotive system in accordance with one or more embodiments.

FIG. 3 shows a smart heating and RAM HVAC assembly installed in an HVAC assembly in accordance with one or more embodiments.

FIG. 4 shows a smart heating and RAM HVAC assembly installed in an HVAC assembly in accordance with one or more embodiments.

FIG. 5 shows an example of a smart heating and RAM HVAC assembly in accordance with one or more embodiments.

FIG. 6 shows an example of a smart heating and RAM HVAC assembly in accordance with one or more embodiments.

FIG. 7 shows an example of a smart heating and RAM HVAC assembly in accordance with one or more embodiments.

FIG. 8 shows an example of a smart heating and RAM HVAC assembly in accordance with one or more embodiments.

FIG. 9 shows an example of a smart heating and RAM HVAC assembly in accordance with one or more embodiments.

FIG. 10 shows a flowchart describing a process for smart heating in an HVAC in accordance with one or more embodiments.

FIG. 11 shows a flowchart describing a process for smart heating and RAM in an HVAC in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include methods, assemblies, and systems directed to fresh and recirculation air inlet design for smart heating and ram air management (RAM). In one or more embodiments, a HVAC assembly may be configured for operating in a partial recirculation mode for smart heating blocking most of the air coming from an outside of a motor vehicle and bypassing a blower. The HVAC system configuration may be useful in hot weather by circulating air in response to immediate changes of speed and temperature surrounding the motor vehicle. Similarly the HVAC assembly may be configured to manage air flows from outside of the motor vehicle to ensure that temperature, humidity, and air pressure parameters from the outside do not affect the interior of the motor vehicle. As such, air inlets with thrust doors may be used for preventing fresh air from blasting into the HVAC assembly and air leakage. Thus, ram air may be managed at high speeds and smart heating may be managed at low blower speed regardless of a pressure at the fresh air inlet.

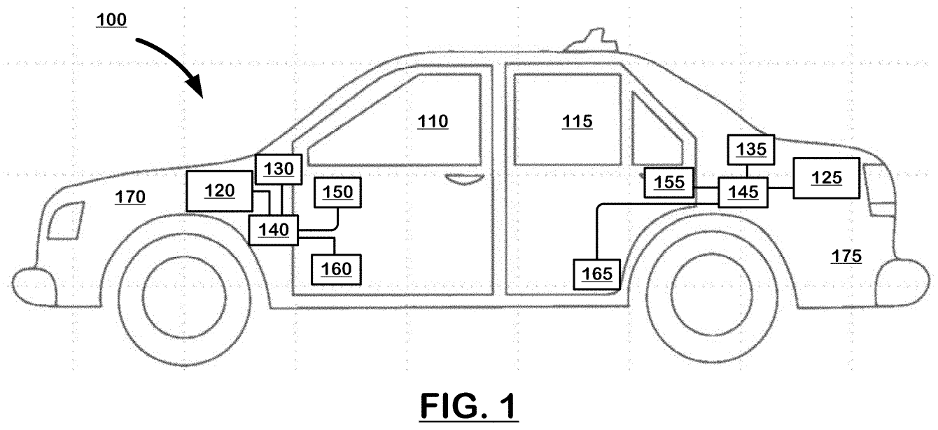

FIG. 1 shows a block diagram of a system in accordance with one or more embodiments. FIG. 1 shows a heating, ventilation, and air-conditioning (HVAC) system (100) for a motor vehicle according to one or more embodiments, having various equipment that is powered during regular operation of the motor vehicle. The HVAC system (100) may be a split HVAC system configured to connect two HVAC subassemblies for the HVAC system (100) to operate. The HVAC system (100) may be a single system installed at the front or at the back of a motor vehicle. Additionally, the HVAC system (100) may be one system divided between two parts, one located at the front and another one located at the back of the motor vehicle. In one or more embodiments, a system, or sub-system, located at the front of the vehicle may include the same elements mirrored in the back of the vehicle. In one or more embodiments, the motor vehicle may be divided into two areas: an area outside passenger compartments (170, 175) and an area inside passenger compartments (110, 115). Furthermore, the system may include a distribution controller (120, 125), an airflow space (130, 135), a blower motor (140, 145), an evaporator (150, 155), and a heater core (160, 165). Those skilled in the art will appreciate that the configuration of FIG. 1 is not limited to that which is shown, and that one or more of the above-mentioned components may be combined or omitted.

The area outside passenger compartments (170, 175) may be any area that a passenger does not have access to through regular use of the motor vehicle. As such, these areas may include under and above the motor vehicle, under the hood at the front of the motor vehicle, or in the trunk at the back of the motor vehicle. This area may be larger in larger vehicles or vehicles that do not require a conventional engine, such as is the case with electric motor vehicles. In a hatchback vehicle, or a vehicle with the back or front exposed to the driver, this area may be considered as any area beyond the dashboard at the front or any area behind the back seats at the back.

The area inside passenger compartments (110, 115) may be any area that any passenger has access to at any point through regular use of the motor vehicle. For example, this area may include any area from the dashboard towards the direction of the driver and any area from the back seats towards the front of the car.

The system may include a blower motor (140, 145) hardware configured to produce regulated burst of rotational force to activate subsequent motors or directly impact flow of air in the airflow chamber and the airflow space (130, 135). For example, the blower motor (140, 145) may be considered a device for enabling a fan to push hot/cold air in/out of the area inside passenger compartments (110, 115).

The airflow space (130, 135) may be hardware configured for transporting airflow inside/outside the motor vehicle. In the HVAC system (100), these components may circulate air in/out of the motor vehicle while avoiding impacting shifting in weights. For example, the airflow space (130, 135) may be coupled to the evaporator (150, 155) and the heater core (160, 165) for moving an airflow through the motor vehicle.

The evaporator (150, 155) and the heater core (160, 165) may be one or more elements of an electric radiator that exchanges heat with at least one fluid to change a temperature level in the distributed airflow.

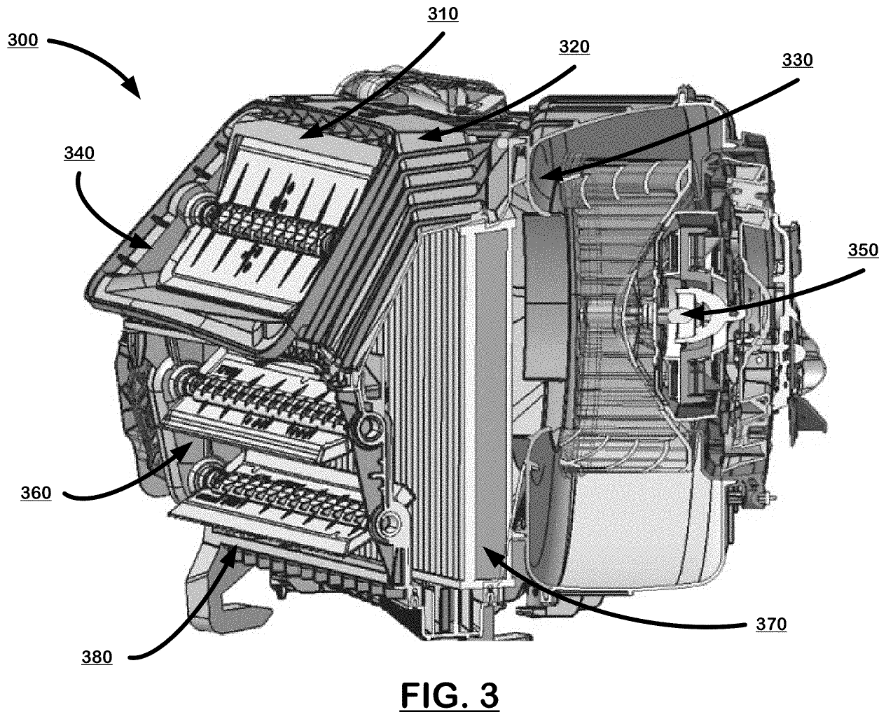

The distribution controller (120, 125) may be a processor or a human-machine interface though which the blower motor (140, 145) is controlled. The distribution controller (120, 125) may be a processor coupled with motors connected to air inlets for distributing airflow in/out the motor vehicle. Further, the distribution controller (120, 125) may control and regulate the use of the evaporator (150, 155) and the heater core (160, 165). For example, the air inlets may be fresh air inlets and recycled air inlets configured to combine mixed air for maintenance of a pressure or a temperature inside a passenger cabin of a motor vehicle. The distribution controller (120, 125) may be coupled to one or more electronic components configured to dynamically modify the aperture of the various air inlets. These means may be electronic components configured for synthesizing and actuating motors coupled to one or more flaps for dynamically modifying an aperture on one or more of the air flaps. In one or more embodiments, these means are subassemblies including sensors connected to the distribution controller (120, 125) that sends out data, or commands to an actuator of a specific air flap. As such, the means may be an Engine Control Unit (ECU) of a motor vehicle. The air inlets and their respective combinations are described in more detail in FIGS. 3-11 below.

The HVAC system (100) may be assembled in at least two distinct subassemblies. As such, the above-referenced elements of the HVAC system (100) may be distributed in one or both of the subassemblies. For example, in one or more embodiments, the evaporator (150, 155) and the blower motor (140, 145) may be part of a first subassembly of the HVAC system (100), located outside of the passenger compartment of the motor vehicle, while the heater core (160, 165) and the distribution controller (120, 125) may be part of a second subassembly of the HVAC system, located inside the passenger compartment of the motor vehicle. Those skilled in the art will appreciate that embodiments disclosed herein are not limited to the aforementioned example of distribution of elements across subassemblies and that these elements may be located in either subassembly without departing from embodiments disclosed herein.

The area outside of the passenger compartment and the area inside the passenger compartment may be split by a wall (not shown). The wall may be, in one or more embodiments, a metal sheet associated with the dashboard (not shown in FIG. 1) of the motor vehicle.

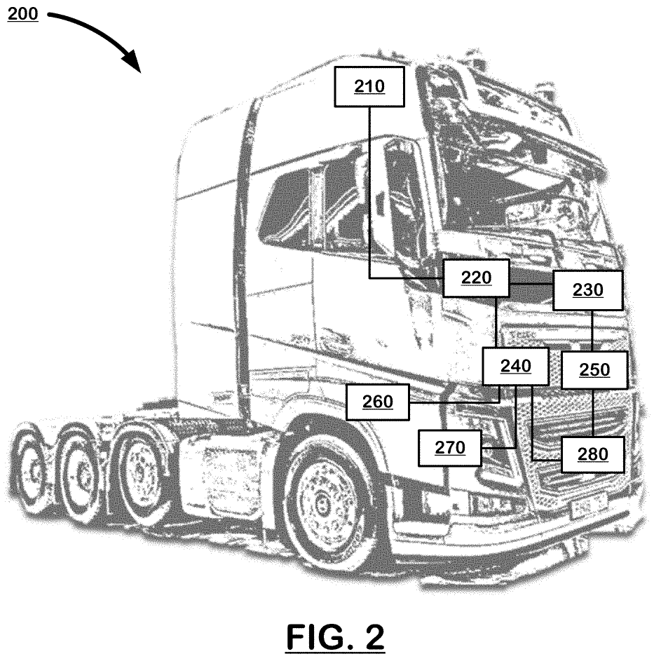

Turning to FIG. 2, FIG. 2 shows a block diagram of an automotive system in accordance with one or more embodiments. FIG. 2 shows an extended HVAC system (200) for a heavy motor vehicle according to one or more embodiments having various equipment that is powered during regular operation of the heavy motor vehicle. The extended HVAC system (200) may be one system divided between two parts, one located at the front and another one located at the back of the heavy motor vehicle, or one located at the top and another one located at the bottom of the heavy motor vehicle. In one or more embodiments, a system, or sub-system, located at the front of the vehicle may include the same elements mirrored in the back of the heavy motor vehicle. In one or more embodiments, the heavy motor vehicle is a truck and may include one or more sensing elements (210, 230, 250), a distribution controller (220), a blower motor (240), an evaporator (260), a heater core (270), and an airflow space (280).

The system may include one or more sensing elements (210, 230, 250), which may be hardware configured to evaluate surrounding areas inside/outside the heavy motor vehicle and provide feedback relating to physical phenomena. In one or more embodiments, the one or more sensing elements (210, 230, 250) may be a first sensing element (210), a second sensing element (230), and a third sensing element (250). The one or more sensing elements (210, 230, 250) may operate individually or in cooperation with one another to provide a distribution controller (220) with information relating to the physical phenomena. The one or more sensing elements (210, 230, 250) may be hardware sensors for sensing/measuring the vehicle environment, such as object detection sensors, temperature sensors, distance sensors, etc. For example, the one or more sensing elements (210, 230, 250) may aid in a self-driving operation of the heavy motor vehicle. In one or more embodiments, the one or more sensing elements (210, 230, 250) may provide a driver with visual/audio signals relating to the surrounding areas of the heavy motor vehicle. Furthermore, the one or more sensing elements (210, 230, 250) may be part of an autonomous operating system that determines various temperature values for the inside of the cabin in the heavy motor vehicle.

The distribution controller (220) may be a processor or a human-machine interface though which the blower motor (240) and the one or more sensing elements (210, 230, 250) are controlled. The distribution controller (220) may be a processor coupled with motors connected to air inlets for distributing airflow in the heavy motor vehicle. Further, the distribution controller (220) may control and regulate the use of the evaporator (260) and the heater core (270).

The blower motor (240) may be hardware configured to produce regulated burst of rotational force to activate subsequent motors or directly impact flow of air in the airflow chamber and the airflow space (280). For example, the blower motor (240) may be considered a device for enabling a fan to push hot/cold air in/out of the area inside a passenger compartment.

The evaporator (260) and the heater core (270) may be one or more elements of an electric radiator that exchanges heat with at least one fluid to change a temperature level in the distributed airflow. In one or more embodiments, the evaporator (260) and the heater core (270) may be assembled during a manufacturing process and the evaporator (260) and the heater core (270) may be afterwards installed within the heavy motor vehicle as part of the extended HVAC system (200). In one or more embodiments, the evaporator (260) and/or the heater core (270) may be serviced through the passenger compartment and without uninstalling any other parts of the extended HVAC system (200).

The airflow space (280) may be hardware configured for transporting airflow inside/outside the heavy motor vehicle through one or more air inlets. In the extended HVAC system (200), this component may circulate air in/out of the motor vehicle while avoiding impacting shifting in weights. For example, the airflow space (280) may be coupled to the evaporator (260) and the heater core (270) for moving an airflow through the motor vehicle. Further, the air inlets may be located both towards an outside and towards an inside of the heavy motor vehicle for providing fresh air and recycled air. The air inlets may be configured for combining different positions based on preset configurations or dynamic adaptive modes. The combinations of air inlets and their respective combinations are described in more detail in FIGS. 3-11 below.

The extended HVAC system (200) may be assembled in at least two distinct subassemblies. As such, the above-referenced elements of the extended HVAC system (200) may be distributed in one or both of the subassemblies. For example, in one or more embodiments, the evaporator (260) and the blower motor (240) may be part of a first subassembly of the extended HVAC system (200), located outside of the passenger compartment of the motor vehicle, while the heater core (270) and the distribution controller (220) may be part of a second subassembly of the HVAC system, located inside the passenger compartment of the motor vehicle. Those skilled in the art will appreciate that embodiments disclosed herein are not limited to the aforementioned example of distribution of elements across subassemblies and that these elements may be located in either subassembly without departing from embodiments disclosed herein.

Turning to FIG. 3, FIG. 3 shows a perspective view of an HVAC assembly in accordance with one or more embodiments. As shown in FIG. 3, the HVAC assembly (300) may be a combination of various subassemblies assembled in a direction of insertion within a motor vehicle. The HVAC assembly (300) may include a RAM air inlet (310) coupled to at least one fresh air inlet (340). The HVAC assembly (300) may include a heat exchanger (370) coupled through an air flow passage (320) to a blower motor (350). The HVAC assembly (300) may include a recycled air inlet (360) coupled to at least one recycled air inlet (380). Further, the blower motor (350) may be coupled to a mixing chamber (330). In particular, air inlets in the HVAC assembly (300) may be managed for positioning from a closed position to an open position.

In one or more embodiments, the RAM air inlet (310) is a RAM air intake configured for reducing intake air velocity by increasing a cross-section area of an intake ducting. To this point, an air inlet may be hardware and software configured at an entry in a casing comprising the HVAC assembly. For example, the air inlet may be a mouth, a passage, a hole or an aperture in the casing in which air can flow inside, and outside, the casing. As such, air inlets may be air flaps corresponding to rotating members that open, or close, a hole in the HVAC. As such, when as velocity of a motor vehicle goes down, a dynamic pressure on the RAM air inlet (310) may be reduced while the static pressure is increased. In particular, the increased static pressure in a plenum chamber may have a positive effect on engine power, both because of the pressure itself and an increased air density provided by the higher pressure. Further, in one or more embodiments, the air velocity is reduced to zero without losses the pressure increase may be calculated accordingly. Further, the RAM air inlet (310) may be a cold air intake. In particular, the RAM air inlet (310) may be placed behind a radiator, where not only air may be hot, but the pressure may be below ambient pressure. As such, RAM-air intake effect may be small, but so may be other mild tuning techniques to increase cylinder filling like using larger, fresh air filters, high flow mass flow sensors, velocity stacks, tuned air box, and large tubes from the filter to the engine.

In one or more embodiments, the RAM air inlet (310) is a short RAM air intake. As such, the RAM air inlet (310) may replace an air intake with a short metal pipe (not shown) and a conical air filter inside an engine bay (not shown). As such, a significant increase in intake air volume may occur in an engine where a factory intake piping was designed with baffles and other sound absorbing materials (e.g., rubber).

In one or more embodiments, a recycled air inlet (380) is an aperture that allows air from inside of a passenger cabin to be transported out of the passenger cabin and back inside the passenger cabin at a different air pressure or at a different temperature.

In one or more embodiments, the fresh air inlet (340) is an air flap coupled directly to the RAM air inlet (310). The fresh air inlet (340) may rotate about an axis of rotation in which a degree of aperture may be selected. In particular, the fresh air inlet may be an air flap rotated about the axis of rotation in a clockwise direction or in a counter-clockwise direction. Further, the degree of aperture of the fresh air inlet (340) may be controlled through precision mechanical or electronic components. As such, the degree of aperture of the fresh air inlet (340) may be determined to a degree of precision. In one or more embodiments, the degree of aperture may be an angle between 0 degrees to 180 degrees. In particular, given the rotational nature of the fresh air inlet, an opening of one end of the air inlet concurrently provides an equivalent rotation on the other end of the air inlet. Further, the RAM air inlet (310) and the fresh air inlet (340) may be equipped with one or more sensors configured for determining one or more physical phenomena. These phenomena may include one or more of: humidity levels, air density, air pressure, and air velocity. In one or more embodiments, the RAM air inlet (310) and the fresh air inlet (340) may receive predictive phenomena information which may allow the fresh air inlet (340) to preemptively adapt to an upcoming physical condition. For example, the fresh air inlet (340) may be positioned at a determined degree of aperture upon receiving a command or predictive phenomena information required for the change in the surroundings of the RAM air inlet (310) and the fresh air inlet (340).

In one or more embodiments, the recycled air inlet (360) is an air inlet coupled directly to the recycled air inlet (380). The recycled air inlet (360) may rotate about an axis of rotation in which a degree of aperture may be selected. In particular, the recycled air inlet (360) may be rotated about the axis of rotation in a clockwise direction or in a counter-clockwise direction. Further, the degree of aperture of the recycled air inlet (360) may be controlled through precision mechanical or electronic components. As such, the degree of aperture of the recycled air inlet (360) may be determined to a degree of precision. In one or more embodiments, the degree of aperture may be an angle between 0 degrees to 180 degrees. In particular, given the rotational nature of the fresh air inlet, an opening of one end of the air inlet concurrently provides an equivalent rotation on the other end of the air inlet. Further, the recycled air inlet (380) and the recycled air inlet (360) may be equipped with one or more sensors configured for determining one or more physical phenomena. These phenomena may include one or more of: humidity levels, air density, air pressure, and air velocity. In one or more embodiments, the recycled air inlet (360) and the recycled air inlet (380) may receive predictive phenomena information which may allow the recycled air inlet (360) to preemptively adapt to an upcoming physical condition. For example, the recycled air inlet (360) may be positioned at a determined degree of aperture upon receiving a command or predictive phenomena information required for the change in the surroundings of the recycled air inlet (360) and the recycled air inlet (380).

The fresh air inlet (310) and the recycled air inlet (360) may be hardware and software configured to adjust dynamically their corresponding degrees of aperture to maintain a mixed air pressure in the motor vehicle. In one or more embodiments, the mixed air pressure is a preset air pressure that may be pre-configured for a specific circumstance or the mixed air pressure is an air pressure determined upon immediate analysis of one or more parameters inside a passenger cabin of the motor vehicle or outside the motor vehicle. As such, the mixed air pressure may be a combination of a pressure obtained from the fresh air inlet (310) and a pressure obtained from the recycled air inlet (360). In addition, the mixed air pressure may be a required mixed air pressure to be obtained in a given time. In this event, the combination of proportional pressures from the fresh air inlet (310) and the recycled air inlet (360) may not be sufficient to achieve the required mixed air pressure and the motor blower (350) may be required for increasing, or reducing, the mixed air pressure to reach the required air pressure. In particular, a deficit or surplus on mixed air pressure from a current mixed air pressure to the required mixed air pressure may be a compensation mixed air pressure generated by combining fresh air and recycled air in the mixing chamber (330). To this point, the required mixed air pressure may be attained by heating, or cooling, the mixed air implementing the electronic actuation of a heat exchanger (370).

In one or more embodiments the parameters may be evaluated to dynamically adjust the degree of aperture of the various air inlets. The various air inlets being configured for rotating simultaneously and/or independent from one another. As such, the various air inlets may be rotated at different speeds, in different directions about their respective axis of rotation, and in response, or irrespective of, one or more parameters inside/outside a passenger cabin of the motor vehicle.

In one or more embodiments, the heat exchanger (370) is radiator component configured to increase the air temperature and pressure in the mixed air chamber (330) and the air flow passageway (320). Further, the heat exchanger (370) may be a heater core or an evaporator based on a predetermined configuration. In one or more embodiments, the heat exchanger (370) may be disposed subsequent to the positioning of the fresh air inlet (340) by coupling the heater core (330) in an environment sealed with the air flow passageway (320) and before the mixed air chamber (330). As such, there may be a direct path from air to flow from the fresh air inlet (340) to the heater core (330) and from the heater core (330) to the mixed air chamber (330). In addition, in one or more embodiments, the heater core (330) may be disposed subsequent to the positioning of the recycled air inlet (360) by coupling the heater core (330) in the environment sealed with the air flow passageway (320). As such, there may be a direct path from air to flow from the recycled air inlet (360) to the heater core (330). As such, the air flow passageway (320) may be the same air flow passageway for fresh air and recycled air.

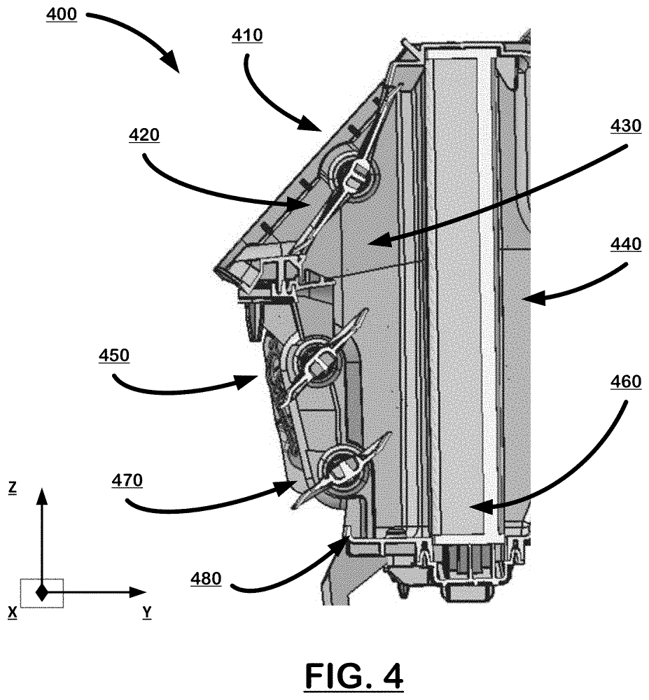

Turning to FIG. 4, FIG. 4 shows a side view of an assembly in accordance with one or more embodiments. As shown in FIG. 4, an HVAC housing assembly (400) may include distinct air flow control subassemblies. These air flow control assemblies may include a fresh air inlet (420) coupled to a RAM air inlet (410), an upper recycled air inlet (450), and a lower recycled air inlet (470). Air inlets and an airflow space may comprise the air inlet housing subassembly that may include a blower motor and a scroll assembly (not shown). A heater core and/or an evaporator (460) may be embedded coupled to an air flow passageway (430) and a mixed air chamber (440). As such, a combination of the various air inlets may be combined for restricting air flow inside HVAC housing assembly (400).

In one or more embodiments, the fresh air inlet (420), the upper recycled air inlet (450), and the lower recycled air inlet (470) may be air flaps that rotate based on a degree of aperture and direction as those described in relation to FIG. 3. For example, the various air flaps may rotate on an X-axis as the axis of rotation to dynamically manage a mixed air pressure inside the HVAC assembly. As such, a number of possible combinations of the various air flaps may be calculated by multiplying the number of degrees of each degree of aperture of each corresponding air flap. Further, the various air flaps may be restricted in rotational motion by a rib (480) disposed at a strategic location to limit the rotation of a given air flap without interfering with the rotation of an air flap other than the air flap for which the rib (480) has been configured. In FIG. 4, the rib (480) limits the rotational movement of the lower recycled air inlet (470) and a person of ordinary skill in the art would readily understand that one or more ribs may be disposed to restrict the rotation of the upper recycled air inlet (450) and to restrict the rotation of the fresh air inlet (420).

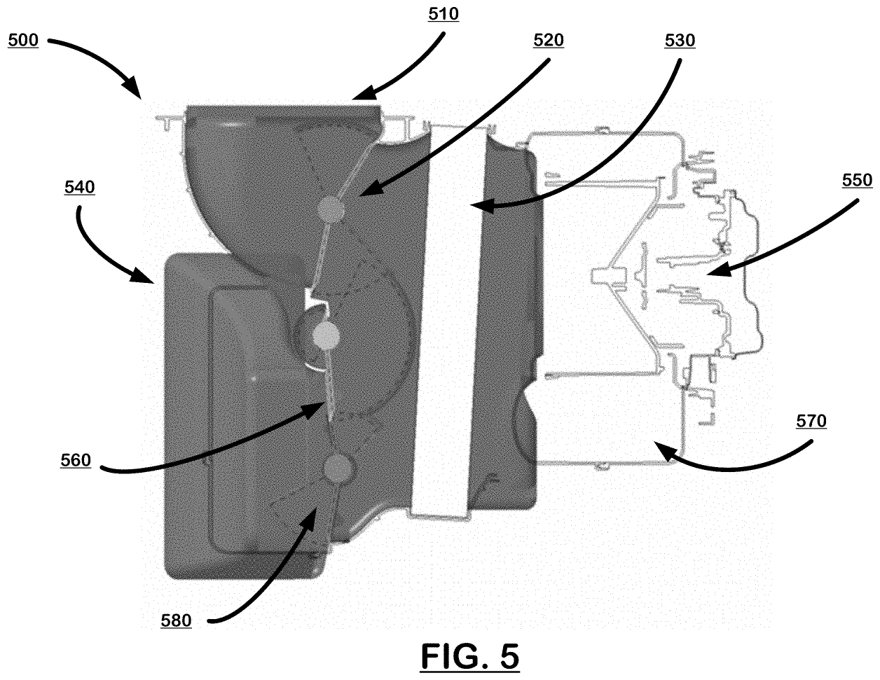

Turning to FIG. 5, FIG. 5 shows a close-up view of an assembly in accordance with one or more embodiments. For example, FIG. 5 may be a close-up of the HVAC assembly (300) described with respect to FIG. 3 or a close-up of the HVAC assembly (400) described with respect to FIG. 4. As shown in FIG. 5, an HVAC assembly (500) may include a RAM air inlet (510) coupled to a fresh air inlet (520). Further, the HVAC assembly (500) may include a recycled air vent (540) coupled to an upper recycled air inlet (560) and to a lower recycled air inlet (580). In one or more embodiments, the fresh air inlet (520), the upper recycled air inlet (560), and the lower recycled air inlet (580) are disposed before a heat exchanger (530) and coupled to a mixed air chamber (570) in which a motor blower (550) may combine fresh air and recycled air.

In one or more embodiments, the HVAC assembly (500) may be configured to start at a sealed off, or closed, mode. In particular, the HVAC assembly (500) may be configured to revert to the closed mode upon powering down of the HVAC assembly (500). As such, the HVAC assembly (500) may remain in a closed mode for shipment or storage. In an event that the HVAC assembly (500) is assembled onto a motor vehicle, the motor vehicle may power down the HVAC assembly (500) at which point fresh air inlet (520), the upper recycled air inlet (560), and the lower recycled air inlet (580) may revert to the closed mode. Further, in one or more embodiments, the closed mode prevents any fresh air or recycled air from entering the air flow passageway and from reaching the heat exchanger (530) and the mixed air chamber (570). Similarly, the blower motor (550) may remain inactive while the HVAC assembly (500) in in the closed mode. For example, the HVAC assembly (500) may dynamically interpret one or more parameters associated to the inside of a passenger cabin to determine that the HVAC assembly is to be configured into the closed mode.

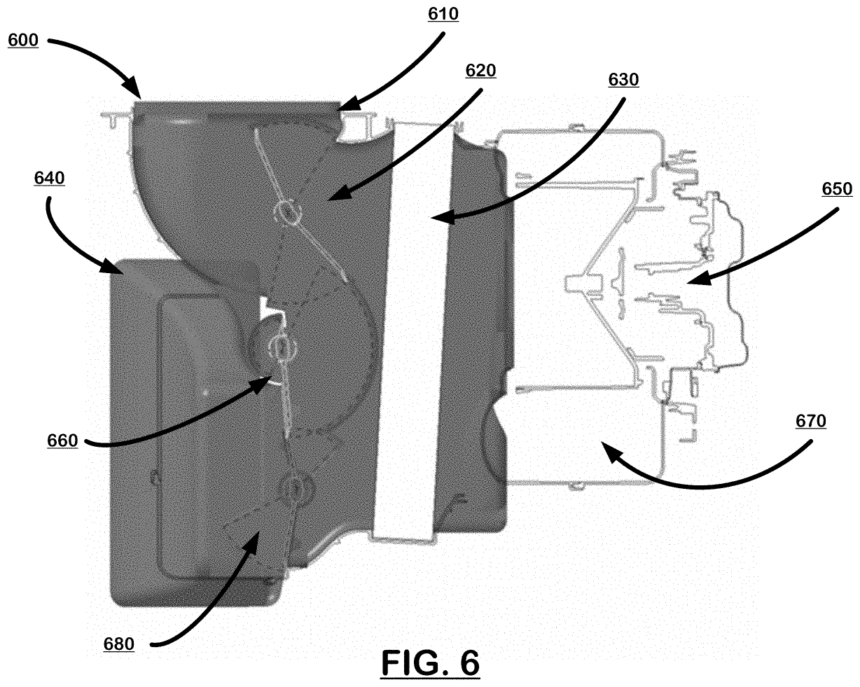

Turning to FIG. 6, FIG. 6 shows a close-up view of an assembly in accordance with one or more embodiments. For example, FIG. 6 may be a close-up of the HVAC assembly (300) described with respect to FIG. 3 or a close-up of the HVAC assembly (400) described with respect to FIG. 4. As shown in FIG. 6, an HVAC assembly (600) may include a RAM air inlet (610) coupled to a fresh air inlet (620). Further, the HVAC assembly (600) may include a recycled air inlet (640) coupled to an upper recycled air inlet (660) and to a lower recycled air inlet (680). In one or more embodiments, the fresh air inlet (620), the upper recycled air inlet (660), and the lower recycled air inlet (680) are disposed before a heat exchanger (630) and coupled to a mixed air chamber (670) in which a motor blower (650) may combine fresh air and recycled air.

In one or more embodiments, the HVAC assembly (600) may be configured to allow passage of fresh air in a fresh air mode. In particular, the HVAC assembly (600) may be configured to prevent passage of recycled air while allowing passage to the fresh air. In this case, the upper recycled air inlet (660) and the lower recycled air inlet (680) may revert to a closed mode. As described above, each of the various air inlets is independent from one another and these air inlets may be configured to perform distinct movements. As such, in fresh air mode, while the upper recycled air inlet (660) and the lower recycled air inlet (680) may be on the closed mode, the fresh air inlet (620) remains open. In one or more embodiments, “open” refers to a degree of aperture of more than 0 degrees and “closed” refers to a degree of aperture of 0 degrees. For example, the HVAC assembly (600) may dynamically interpret one or more parameters associated to the inside of a passenger cabin to determine that the HVAC assembly is to be configured into the fresh air mode.

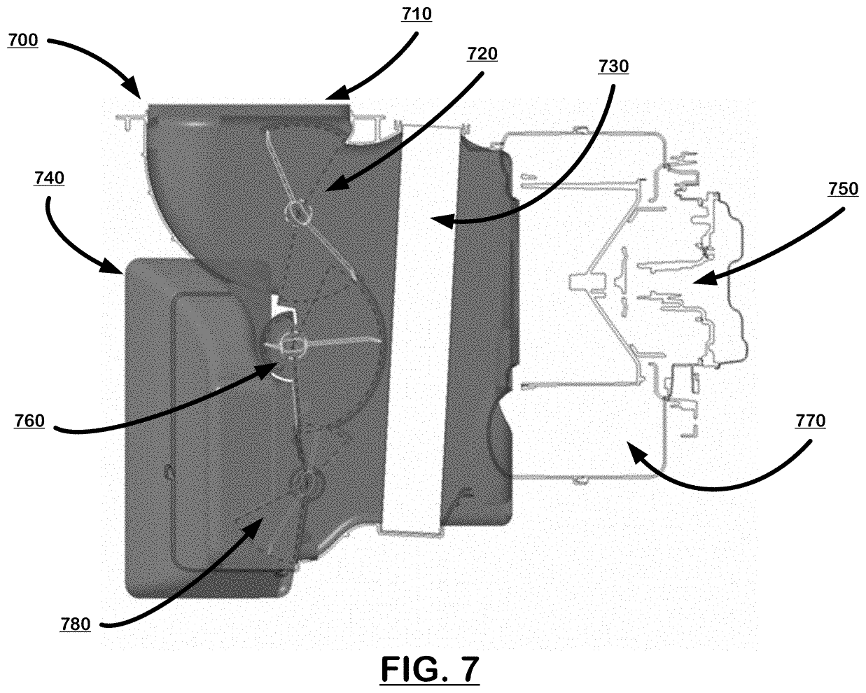

Turning to FIG. 7, FIG. 7 shows a close-up view of an assembly in accordance with one or more embodiments. For example, FIG. 7 may be a close-up of the HVAC assembly (300) described with respect to FIG. 3 or a close-up of the HVAC assembly (400) described with respect to FIG. 4. As shown in FIG. 7, an HVAC assembly (700) may include a RAM air inlet (710) coupled to a fresh air inlet (720). Further, the HVAC assembly (700) may include a recycled air inlet (740) coupled to an upper recycled air inlet (760) and to a lower recycled air inlet (780). In one or more embodiments, the fresh air inlet (720), the upper recycled air inlet (760), and the lower recycled air inlet (780) are disposed before a heat exchanger (730) and coupled to a mixed air chamber (770) in which a motor blower (750) may combine fresh air and recycled air.

In one or more embodiments, the HVAC assembly (700) may be configured to allow passage of fresh air and to allow passage of recycled air in a partial recirculation mode. In particular, the HVAC assembly (700) may be configured to prevent passage of some recycled air while allowing passage to some recycled air and allowing passage to the fresh air. In this case, the upper recycled air inlet (760) and the lower recycled air inlet (780) may be open without any of the recycled air inlet being open at a degree of aperture of 180 degrees, or fully open. As described above, each of the various air inlets is independent from one another and these air inlets may be configured to perform distinct movements. As such, in partial recirculation mode, the upper recycled air inlet (760), the lower recycled air inlet (780), and the fresh air inlet (720) may be open, although partially open. In one or more embodiments, “open” refers to a degree of aperture of more than 0 degrees and “closed” refers to a degree of aperture of 0 degrees. For example, the HVAC assembly (700) may dynamically interpret one or more parameters associated to the inside of a passenger cabin to determine that the HVAC assembly is to be configured into the partial recirculation mode.

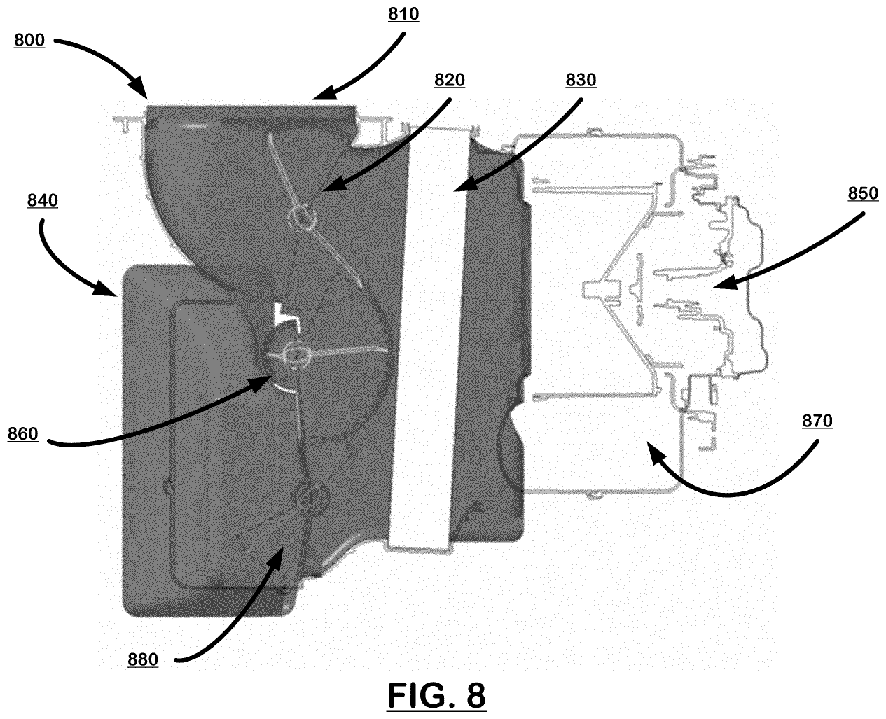

Turning to FIG. 8, FIG. 8 shows a close-up view of an assembly in accordance with one or more embodiments. For example, FIG. 8 may be a close-up of the HVAC assembly (300) described with respect to FIG. 3 or a close-up of the HVAC assembly (400) described with respect to FIG. 4. As shown in FIG. 8, an HVAC assembly (800) may include a RAM air inlet (810) coupled to a fresh air inlet (820). Further, the HVAC assembly (800) may include a recycled air inlet (840) coupled to an upper recycled air inlet (860) and to a lower recycled air inlet (880). In one or more embodiments, the fresh air inlet (820), the upper recycled air inlet (860), and the lower recycled air inlet (880) are disposed before a heat exchanger (830) and coupled to a mixed air chamber (870) in which a motor blower (850) may combine fresh air and recycled air.

In one or more embodiments, the HVAC assembly (800) may be configured to allow passage of fresh air and to allow passage of recycled air in a partial recirculation mode. In particular, the HVAC assembly (800) may be configured to allow passage to the recycled air and to the fresh air. In this case, the upper recycled air inlet (860) and the lower recycled air inlet (880) may be open with any of the recycled air inlet being open at a degree of aperture of 180 degrees, or fully open. As described above, each of the various air inlets is independent from one another and these air inlets may be configured to perform distinct movements. As such, in partial recirculation mode, the upper recycled air inlet (860), the lower recycled air inlet (880), and the fresh air inlet (820) may be fully open. In one or more embodiments, “open” refers to a degree of aperture of more than 0 degrees and “closed” refers to a degree of aperture of 0 degrees. For example, the HVAC assembly (800) may dynamically interpret one or more parameters associated to the inside of a passenger cabin to determine that the HVAC assembly is to be configured into the partial recirculation mode.

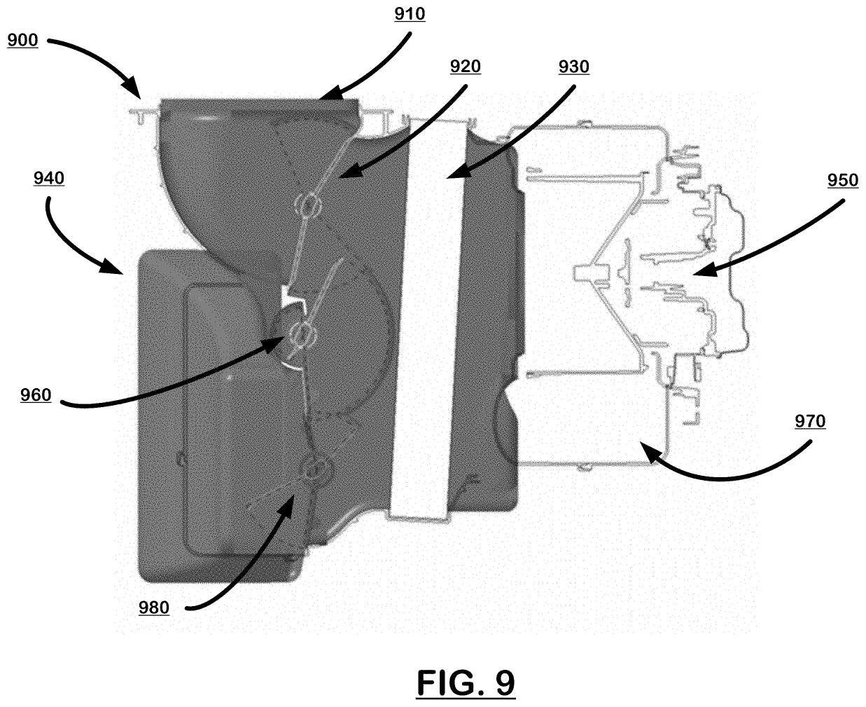

Turning to FIG. 9, FIG. 9 shows a close-up view of an assembly in accordance with one or more embodiments. For example, FIG. 9 may be a close-up of the HVAC assembly (300) described with respect to FIG. 3 or a close-up of the HVAC assembly (400) described with respect to FIG. 4. As shown in FIG. 9, an HVAC assembly (900) may include a RAM air inlet (910) coupled to a fresh air inlet (920). Further, the HVAC assembly (900) may include a recycled air inlet (940) coupled to an upper recycled air inlet (960) and to a lower recycled air inlet (980). In one or more embodiments, the fresh air inlet (920), the upper recycled air inlet (960), and the lower recycled air inlet (980) are disposed before a heat exchanger (930) and coupled to a mixed air chamber (970) in which a motor blower (950) may combine fresh air and recycled air.

In one or more embodiments, the HVAC assembly (900) may be configured to prevent passage of fresh air and to allow passage of recycled air in a full recirculation mode. In particular, the HVAC assembly (900) may be configured to allow passage to the recycled air and to prevent passage of the fresh air. In this case, the upper recycled air inlet (960) and the lower recycled air inlet (980) may be open with any of the recycled air inlet being open at a degree of aperture of 180 degrees, or fully open. As described above, each of the various air inlets is independent from one another and these air inlets may be configured to perform distinct movements. As such, in full recirculation mode, the upper recycled air inlet (960) and the lower recycled air inlet (980) may be fully open while the fresh air inlet (920) remains closed. In one or more embodiments, “open” refers to a degree of aperture of more than 0 degrees and “closed” refers to a degree of aperture of 0 degrees. For example, the HVAC assembly (900) may dynamically interpret one or more parameters associated to the inside of a passenger cabin to determine that the HVAC assembly is to be configured into the full recirculation mode.

While one or more embodiments have been discussed with respect to “closed mode,” “fresh air mode,” “partial recirculation mode,” and “full recirculation mode,” a person of ordinary skill in the art would understand that the HVAC assemblies discussed in view of FIGS. 5-9 may be interchanged. As such, the various HVAC assemblies may be configured for dynamically interchanging modes upon receiving a command or upon identifying predetermined circumstances previously identified as triggers.

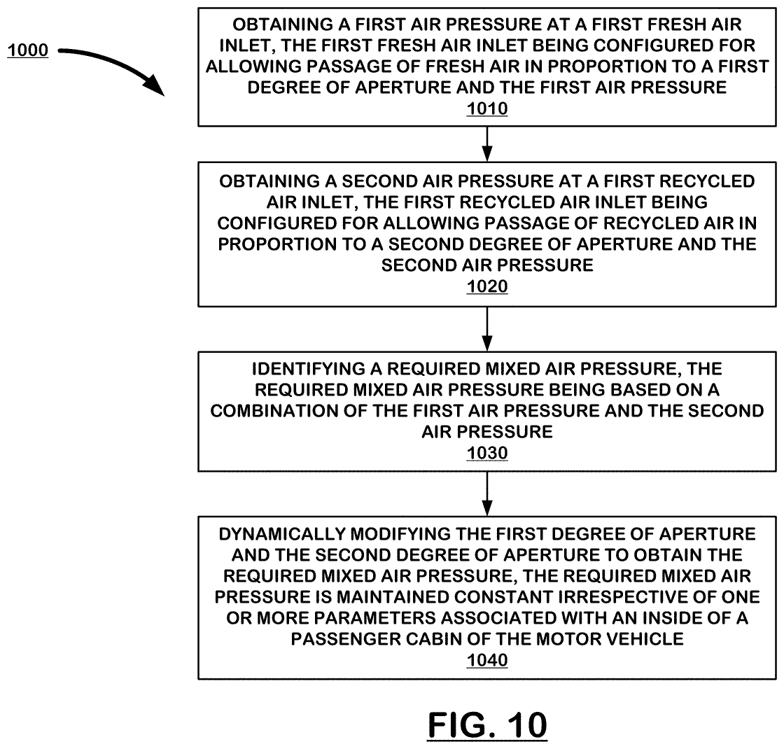

Turning to FIG. 10, FIG. 10 shows a flowchart in accordance with one or more embodiments. Specifically, FIG. 10 describes a method (1000) for smart heating and RAM using an HVAC assembly for a motor vehicle. One or more blocks in FIG. 1 or 2 may be performed by one or more components as described above in FIGS. 3-9. While the various blocks in FIG. 10 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 1010, a first air pressure is obtained at a first fresh air inlet, the first fresh air inlet being configured for allowing passage of fresh air in proportion to a first degree of aperture and the first air pressure in accordance to one or more embodiments. For example, a sensor at the first fresh air inlet may identify a value of pressure which may be translated based upon its physical relations with velocity, volume, and temperature. As such, the sensor configured for identifying the pressure of air at the first fresh air inlet may also measure velocity of an air flow causing the pressure and a temperature of the fresh air flow.

In Block 1020, a second air pressure is obtained at a first recycled air inlet, the first recycled air inlet being configured for allowing passage of recycled air in proportion to a second degree of aperture and the second air pressure in accordance to one or more embodiments. For example, as described under Block 1010, a sensor at the first recycled air inlet may identify a value of pressure which may be translated based upon its physical relations with velocity, volume, and temperature. As such, the sensor configured for identifying the pressure of air at the first recycled air inlet may also measure velocity of an air flow causing the pressure and a temperature of the recycled air flow.

In Block 1030, a required mixed air pressure is identified, the required mixed air pressure being based on a combination of the first air pressure and the second air pressure in accordance to one or more embodiments. As commands arrive to the HVAC assembly, the HVAC assembly evaluates instructions of required functions, such as supplying a specific temperature or pressure to a passenger cabin. In particular, the HVAC assembly may receive a command for attaining a required temperature. In response, the HVAC assembly may evaluate the pressure, temperature, and velocity of air flow at the fresh air inlet and at the recycled air inlet. As such, the HVAC assembly may determine that a specific combination of degrees of aperture for each, or any, of the air inlets may be required for supplying the required temperature of mixed air pressure.

In one or more embodiments, a blower motor may be actuated for combining fresh air and recycled air. Similarly, to obtain the required mixed air pressure, a heater core may be actuated to shift air pressure, and by definition, the temperature pressure.

In Block 1040, the first degree of aperture and the second degree of aperture are dynamically modified to obtain the required mixed air pressure, the required mixed air pressure is maintained constant irrespective of one or more parameters associated with an inside of a passenger cabin of the motor vehicle in accordance to one or more embodiments. The passenger cabin may be monitored to obtain several parameters associated with it. In particular, information and parameters relating to an inside temperature, pressure, or humidity level may be obtained through one or more sensing devices. For example, the sensing devices may be hardware or software configured to sample physical phenomena. This step may include, for example, automatically adapting the degree of aperture of each of the various air inlets to accommodate an optimum configuration for the air inlets to meet a user demand. Alternatively, this step may include, for example, automatically adapting the degree of aperture of each of the various air inlets to accommodate an optimum configuration for the air inlets to meet a minimum energy usage.

In one or more embodiments, “automatically” refers to dynamically adapting the openings of the air inlets without a user's interference in accordance to one or more embodiments. Further, in one or more embodiments, “dynamically adapting” is performed without the use of electronics and is automatically determined upon perception of mechanical flaps actively shifting degrees of apertures for each of the air inlets. In particular, while a blower motor and a heater core may intervene to obtain the required mixed air pressure, the mixed air pressure may be obtained without electrical intervention in the adjustment of the various inlets.

In one or more embodiments, the same configurations and in opposite behavior are applied to the various air inlets. As such, inverse configurations to those shown in FIGS. 1-10 may be configured for the HVAC assembly.

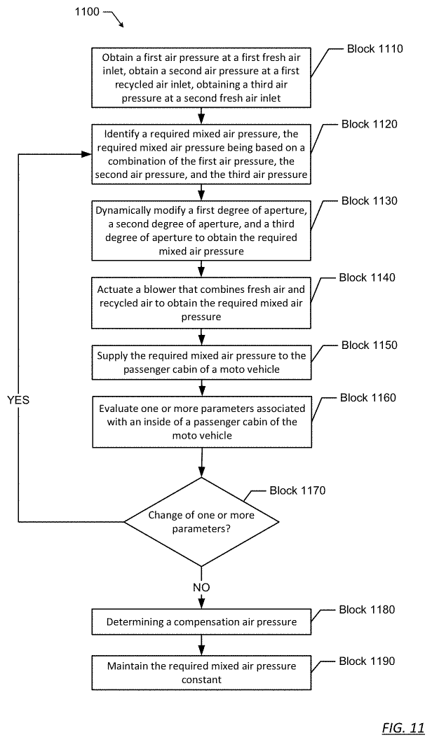

Turning to FIG. 11, FIG. 11 shows a flowchart in accordance with one or more embodiments. Specifically, FIG. 11 describes a method (1100) for smart heating and RAM using an HVAC assembly for a motor vehicle. One or more blocks in FIG. 1 or 2 may be performed by one or more components as described above in FIGS. 3-9. While the various blocks in FIG. 11 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 1110, first air pressure is obtained at a first fresh air inlet, a second air pressure is obtained at a first recycled air inlet, a third air pressure is obtained at a second fresh air inlet in accordance to one or more embodiments. For example, the various air inlets discussed in reference to FIGS. 1-9 may be arranged to obtain one or more pressure values. As described above, by definition, pressure samples associated to air flow may provide volume and temperature information.

In Block 1120, a required mixed air pressure is identified, the required mixed air pressure being based on a combination of the first air pressure, the second air pressure, and the third air in accordance to one or more embodiments. For example, a specific pressure or temperature may be requested or selected in a passenger cabin. In one or more embodiments, this required temperature or pressure may be treated as the required air pressure.

In Block 1130, a first degree of aperture, a second degree of aperture, and a third degree of aperture are dynamically modified to obtain the required mixed air pressure in accordance to one or more embodiments. For example, each of the degrees of aperture corresponding to each of the air inlets may be actively adapted, or dynamically modified, as immediate response to factors affecting pressure and temperature levels inside an HVAC assembly. In particular, the degrees of aperture may perform adaptive behavior automatically in response to changes inside the passenger cabin.

In one or more embodiments, the one or more parameters are selected from a group consisting of: a humidity level, a difference in temperature with an outside of the passenger cabin, a pressure on a RAM door, and a position of a blower switch. As such, by modifying the temperature in the manner discussed above, for example, the humidity level may be controlled for preventing fogginess of the vehicle windows.

In Block 1140, a blower combines fresh air and recycled air to obtain the required mixed air pressure in accordance to one or more embodiments. In particular, the blower may be a blower motor that directly received fresh air and/or recycled air. As such, the blower may easily combine the fresh air and the recycled air by rotating at a strength proportional to the required temperature or mixed air pressure.

In Block 1150, the required mixed air pressure is supplied to the passenger cabin of a motor vehicle in accordance to one or more embodiments. In such event, one or more parameters associated to the passenger cabin may be controlled. For example, a humidity level may be reduced based on dry air being pushed into the passenger cabin.

In Block 1160, one or more parameters associated with an inside of a passenger cabin of the motor vehicle are evaluated in accordance to one or more embodiments. In such event, the inside of the passenger cabin is sampled for one or more parameters and these parameters are evaluated to determine triggers for changing a required mixed air pressure.

In Block 1170, a determination is made as to whether a change of one or more of the parameters has occurred in accordance to one or more embodiments. In such event, a decision is made to determine whether one or more parameters have been modified. If it is determined that the one or more parameters were not changed, the method proceeds to Block 1180 to determine a compensation air pressure associated with the required mixed air pressure. For example, a level of humidity may remain the same inside the passenger cabin and the required mixed air pressure stays the same allowing further actuation in the HVAC assembly. In particular, the HVAC assembly may proceed to reach the previously identified required mixed air pressure. Alternatively, if one or more parameters are determined to change, the method moves to Block 1120 to identify a new required mixed air pressure. For example, if the humidity in the passenger cabin where to change, a new mixed air pressure may be required in the HVAC assembly to reach a required temperature value.

In Block 1180, a compensation air pressure is determined in accordance to one or more embodiments. In such event, a difference between a current pressure and the required mixed air pressure is determined. As such, a decision is made to reach the required mixed air pressure by any of the modes discussed above.

In Block 1190, the required mixed air pressure is maintained constant in accordance to one or more embodiments. In such event, the required mixed air pressure is maintained irrespective of changes in the one or more parameters. Similarly, the HVAC assembly may be configured to determine new compensation is pressure values to maintain a constant temperature inside the passenger cabin.

In one or more embodiments, the same configurations and in opposite behavior are applied to the various air inlets. As such, inverse configurations to those shown in FIGS. 1-11 may be configured for the HVAC assembly.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method for smart heating and a Recirculation Air Management (RAM) using a heating, ventilation, and air-conditioning (HVAC) assembly for a motor vehicle, the method comprising:
obtaining a first air pressure at a first fresh air inlet, the first fresh air inlet being configured for allowing passage of fresh air in proportion to a first degree of aperture of the first fresh air inlet and the first air pressure;
obtaining a second air pressure at a first recycled air inlet, the first recycled air inlet being configured for allowing passage of recycled air in proportion to a second degree of aperture of the first recycled air inlet and the second air pressure;
identifying a required mixed air pressure, the required mixed air pressure being based on a combination of the first air pressure and the second air pressure; and
dynamically modifying the first degree of aperture and the second degree of aperture to obtain the required mixed air pressure,
wherein the required mixed air pressure is maintained constant irrespective of one or more parameters associated with an inside of a passenger cabin of the motor vehicle.

2. The method of claim 1, the method further comprising:
obtaining a third air pressure at a second recycled air inlet, the second recycled air inlet being configured for allowing passage of recycled air in proportion to a third degree of aperture of the second recycled air inlet and the third air pressure.

3. The method of claim 2, the method further comprising:
dynamically modifying the first degree of aperture, the second degree of aperture, and the third degree of aperture to obtain the required mixed air pressure,
wherein the required mixed air pressure is based on a combination of the first air pressure, the second air pressure, and the third air pressure.

4. The method of claim 2,
wherein the first fresh air inlet, the first recycling air inlet, and the second recycled air inlet are configured to dynamically move from a closed position to an open position.

5. The method of claim 1, the method further comprising:
actuating a blower that combines fresh air and recycled air to obtain the required mixed air pressure; and
supplying the required mixed air pressure to the passenger cabin.

6. The method of claim 3, the method further comprising:
determining a compensation air pressure, the compensation air pressure being a difference between the required air pressure and a combination of the first air pressure and the second air pressure; and
actuating the blower to combine the fresh air and the recycled air to supply the compensation air pressure to obtain the required mixed air pressure.

7. The method of claim 4,
wherein a temperature of the passenger cabin is maintained constant irrespective of the one or more parameters associated with the inside of the passenger cabin.

8. The method of claim 7,
wherein the temperature is a predetermined temperature value.

9. The method of claim 1,
wherein the one or more parameters are selected from a group consisting of: a humidity level, a difference in temperature with an outside of the passenger cabin, a pressure on a RAM door, and a position of a blower switch.

10. A heating, ventilation, and air-conditioning (HVAC) assembly for smart heating and a Recirculation Air Management (RAM) of a motor vehicle, the assembly comprising:
a first fresh air inlet configured for allowing passage of fresh air in proportion to a first degree of aperture and a first air pressure; and
a first recycled air inlet configured for allowing passage of recycled air in proportion to a second degree of aperture and a second air pressure; and
means configured to dynamically modify the first degree of aperture and the second degree of aperture to maintain a mixed air pressure constant irrespective of one or more parameters associated with an inside of a passenger cabin of the motor vehicle, and
wherein the first air pressure and the second air pressure are combined to form a required mixed air pressure.

11. The assembly of claim 10, the assembly further comprising:
a second recycled air inlet configured for allowing passage of recycled air in proportion to a third degree of aperture and a third air pressure, the third air pressure being a pressure on the second fresh air inlet.

12. The assembly of claim 11,
wherein the first degree of aperture, the second degree of aperture, and the third degree of aperture are dynamically modified to obtain the required mixed air pressure,
wherein the required mixed air pressure is based on a combination of the first air pressure, the second air pressure, and the third air pressure.

13. The assembly of claim 10,
wherein the means comprise an Engine Control Unit (ECU) of the motor vehicle coupled to one or more sensors configured to actuate the first fresh air inlet, the first recycling air inlet, or the second recycled air inlet.

14. The assembly of claim 11,
wherein the first fresh air inlet, the first recycling air inlet, and the second recycled air inlet are configured to dynamically move from a closed position to an open position.

15. The assembly of claim 10, the assembly further comprising:
a blower that combines fresh air and recycled air to obtain the required mixed air pressure; and
wherein the blower supplies the required mixed air pressure to the passenger cabin.

16. The assembly of claim 10, the assembly further comprising:
a controller that determines a compensation air pressure, the compensation air pressure being a difference between the required air pressure and a combination of the first air pressure and the second air pressure,
wherein the blower combines the fresh air and the recycled air to supply the compensation air pressure to obtain the required mixed air pressure.

17. The assembly of claim 10,
wherein a temperature of the passenger cabin is maintained constant irrespective of the one or more parameters associated with the inside of the passenger cabin.

18. The assembly of claim 10,
wherein the one or more parameters are selected from a group consisting of: a humidity level, a difference in temperature with an outside of the passenger cabin, a pressure on a RAM door, and a position of a blower switch.

19. A Recirculation Air Management (RAM) air intake for a heating, ventilation, and air-conditioning (HVAC) assembly for smart heating and RAM of a motor vehicle, the assembly comprising:
a first fresh air inlet configured for allowing passage of fresh air in proportion to a first degree of aperture and a first air pressure; and
a first recycled air inlet configured for allowing passage of recycled air in proportion to a second degree of aperture and a second air pressure; and
means configured to dynamically modify the first degree of aperture and the second degree of aperture to maintain a mixed air pressure constant irrespective of one or more parameters associated with an inside of a passenger cabin of the motor vehicle, and
wherein the first air pressure and the second air pressure are combined to form a required mixed air pressure.

20. The assembly of claim 19,
wherein the means comprise an Engine Control Unit (ECU) of the motor vehicle coupled to one or more sensors configured to actuate the first fresh air inlet, or the first recycling air inlet.
